(19) United States
(12) Patent Application Publication
(10) Pub. No.: US 2015/0254280 A1
(43) Pub. Date: Sep. 10, 2015

(54) Hybrid Indexing with Grouplets

(71) Applicant: NEC Laboratories America, Inc., Princeton, NJ (US)

(72) Inventors: Xiaoyu Wang, Sunnyvale, CA (US); Yuanqing Lin, Sunnyvale, CA (US); Qi Tian, Princeton, NJ (US)

(21) Appl. No.: 14/628,286

(22) Filed: Feb. 22, 2015

Related U.S. Application Data
(60) Provisional application No. 61/948,903, filed on Mar. 6, 2014.
(60) Provisional application No. 62/030,677, filed on Jul. 30, 2014.

(51) Int. Cl. G06F 17/30

(52) U.S. Cl. CPC G06F 17/30256; G06F 17/30598; G06F 17/30312; G06F 17/3053

(57) ABSTRACT

Systems and methods are disclosed to respond to a query for one or more images by using a processor, applying an indexing strategy which processes images as grouplets rather than individual single images; generating a two layer indexing structure with a group layer, each associated with one or more images in an image layer; cross-indexing the images into two or more groups; and retrieving near duplicate images with the cross-indexed images and the grouplets.

This application claims priority to Provisional Application Ser. No. 61/948,903 filed Mar. 6, 2014 and 62030677 filed Jul. 30, 2014, the content of which is incorporated by reference.

Image retrieval contains three important procedures, i.e., feature extraction, off-line indexing, and online retrieval. Among the three procedures, off-line indexing organizes the relevant images together to eliminate redundancy and makes them easy to access during online retrieval. Therefore, indexing strategy largely influences the retrieval accuracy, time and memory costs. Nowadays, tons of works have been published focusing on extracting better image features and designing more accurate online retrieval algorithms, but the effort on better indexing strategy is relatively limited.

Other works use inverted index to index the image ID in the database. The indexing is done in a per image manner. They do not extensively explore the correlation in database images, either. In these methods, local invariant image features are extracted to capture local low-level content which are robust to local transformations. An image typically generates about 1000 feature points. Database images are indexed using these local features.

Despite the great success of these approaches in local descriptor based image retrieval, most of existing works follow the one-layer “descriptor to image” indexing structure. Although being very effective, it has several obvious drawbacks. Firstly, image databases usually store multiple copies of similar objects or scenes, especially those having millions of images. A group of local descriptors may also appear frequently in multiple images. Although frequently appeared descriptors are down-weighted using inverted document frequency, the “descriptor to image” indexing does not have a strategy to eliminate such redundance across images to save memory. In other words, current indexing scheme causes potentially higher memory cost than necessary. Secondly, recent advances in large-scale image classification and saliency analysis may help with conducting robust similarity analysis among images. Because current indexing is performed for each image individually, it is not straightforward to embed complex database image relations into current framework for online retrieval.

Most of current image indexing systems for image retrieval view database as a set of individual images. It limits the flexibility of the retrieval framework to conduct sophisticated cross image analysis, resulting in higher memory consumption and sub-optimal retrieval accuracy.

### SUMMARY

In one aspect, systems and methods are disclosed to respond to a query for one or more images by using a processor, applying an indexing strategy which processes images as grouplets rather than individual single images; generating a two layer indexing structure with a group layer, each associated with one or more images in an image layer; cross-indexing the images into two or more groups; and retrieving near duplicate images with the cross-indexed images and the grouplets.

In another aspect, the system contains two procedures: 1) grouplet generation and 2) grouplet based indexing and retrieval. Because images within each grouplet are indexed and retrieved as one unit, they are required to be highly relevant with each other to ensure the retrieval precision. To discover such grouplets in a large-scale image database, we build sparse graphs where the vertexes are images and the links denote the mutual k-Nearest Neighbor (kNN) relationships computed in different ways. Then in such graphs, we seek the maximal cliques as grouplets. Each maximal clique is a subgraph where any two vertexes are linked, thus the images in it would be highly relevant with each other. After generating different types of grouplets, we follow the classic BoWs (Bag-of-visualWords) indexing procedure to index them, i.e., extracting local descriptors, computing TF (Term Frequency) vectors with pooling strategy, and building inverted file indexes. During online retrieval stage, we also follow the BoWs retrieval procedure and only extract local descriptors from the query to retrieve relevant grouplets, then unpack them and rank the individual images.

Advantages of the system may include one or more of the following. Our method treats the database images as joint sets of groups. Each group consists of a set of images which has high correlation base on either local similarity or global semantic similarities. In constant to most previous works which index each individual image, we apply the indexing for each group. Because groups are constructed in a way that images in a specific group are similar in some respect, local descriptors in a group are highly redundant. Redundant descriptors only need to be indexed once which significantly reduces the memory usage. In the process of group construction, both global high level features as well as local features are taken into account to support robust indexing.

Our approach shows better precision, efficiency and memory cost, i.e., about 130% and 50% memory cost of baseline BoWs model if three types and one type of grouplets are considered, respectively. Therefore, we conclude that our approach is superior to the existing indexing approaches in the aspects of precision, efficiency, and memory cost. The system seamlessly integrates various content analysis techniques. Our approach is largely different from many recent retrieval approaches working on feature extraction and online retrieval. These approaches can be integrated with our indexing strategy to for better performance. Our online retrieval only extracts local descriptors, but is able to consider and integrate multiple image similarities. This is superior to many retrieval fusion approaches, which introduce extra computations and memory costs by fusing different features or multiple retrieval results during online retrieval.

### BRIEF DESCRIPTION OF THE DRAWINGS

FIG. 1 shows an exemplary database indexing process.

FIG. 2 shows an exemplary indexing structure.

FIG. 3 shows an exemplary group generation module.

FIG. 4 shows an exemplary module to cross-connect images to a group mapping.

FIG. 5 shows an exemplary computer to execute the system of FIGS. 1-4.

### DESCRIPTION

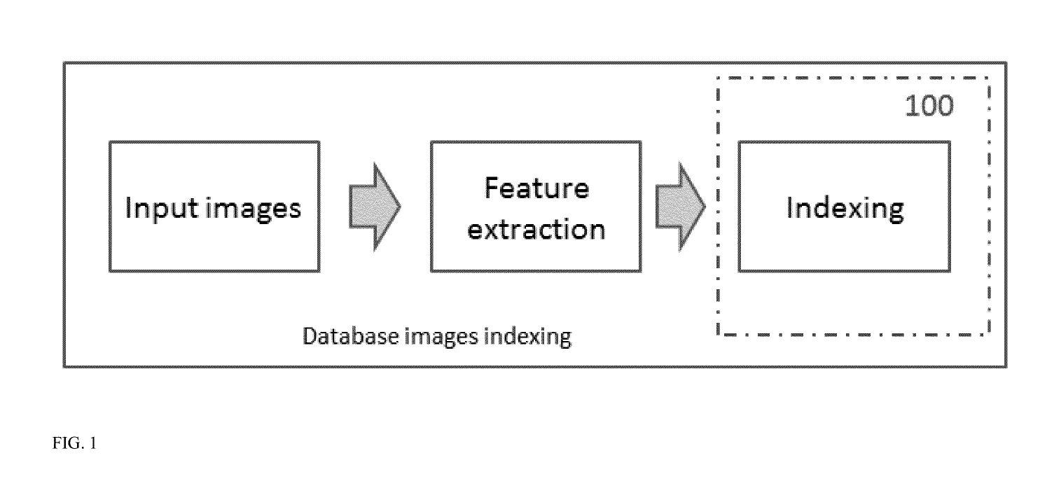

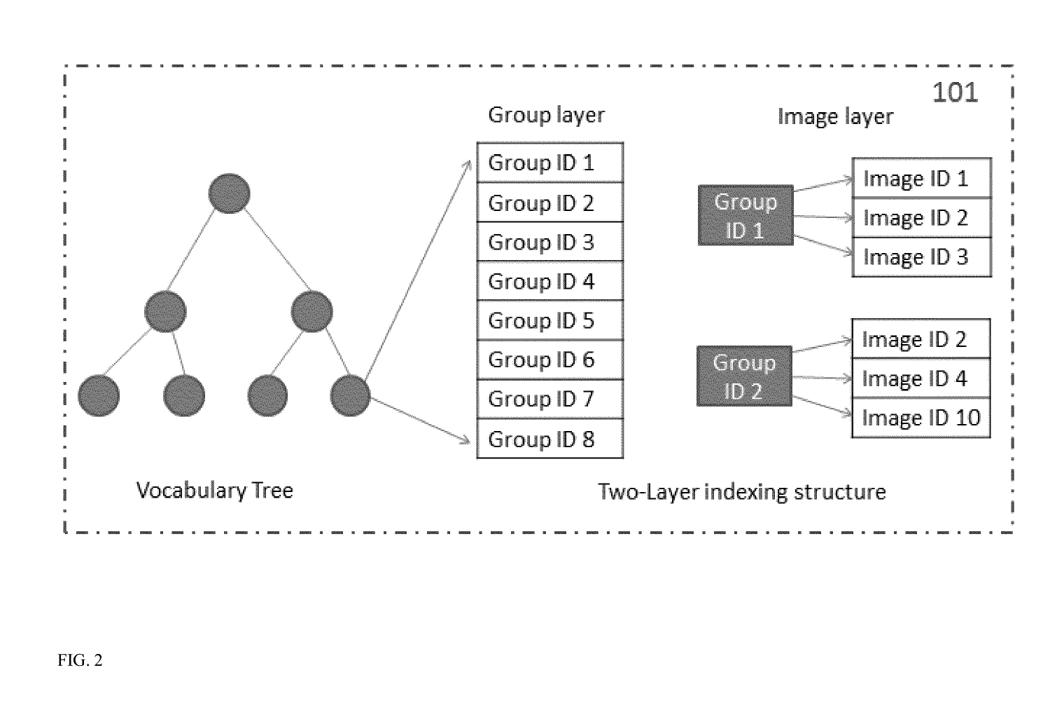

Turning now to the figures, FIG. 1 has an indexing engine 100 for indexing groups in contrast to indexing images. Details are explained in blocks 101, 102 and 103 of FIGS. 2-4. The system of FIGS. 1-4 provides a compact, discriminative and flexible indexing strategy for local descriptor based image retrieval. In contrast to the “descriptor to image” single layer indexing, we index database images using a two-layer structure: “descriptor to grouplet” and “grouplet to image”. The intermediate grouplet layer models sophisticated cross image relations and eliminates redundances among images. We named it grouplet because we use small but many groups to enforce strong image correlations. The indexing framework encodes mutual information across multiple images simultaneously, thus we call it cross indexing to differentiate it from the indexing of individual images. As illustrated in FIG. 1, indexing grouplets rather than individual images is able to achieve more compact index file because the number of grouplets could be significantly smaller than the number of images. More importantly, grouplet approach allows us to seamlessly integrate different image features and image content analysis techniques during off-line cross indexing.

Cross indexing consists of two main steps: 1) grouplet generation and 2) grouplet indexing. We formulate grouplet generation as seeking all maximal cliques in a sparse graph, where vertexes are images and links denote the mutual k-Nearest Neighbor (kNN) relations computed with customized similarity measurements. As shown in FIG. 1, we propose to generate grouplets via various similarity measurements, i.e., local similarity, regional similarity, and global similarity. The resulting grouplets are indexed together in inverted file indexes. In this manner, images with similar local descriptors, similar object regions, or similar semantics are organized together in an unified framework. It significantly improves the discriminative power of the index file and hence produces robust retrieval results.

Our online retrieval follows the BoWs (Bag-of-visual Words) retrieval procedure and first extracts local descriptors from the query to retrieve relevant grouplets. Images are then retrieved from grouplets using the grouplet-image correspondences obtained during grouplet construction. Although only local descriptors are used for online query, images sharing similar local descriptors, similar object regions, and similar semantics could be retrieved, because the intermediate grouplet layer models sophisticated image relations. We test our approach on several image retrieval benchmark datasets. Compared with recent image retrieval algorithms, our approach shows lower memory cost, higher efficiency, and competitive accuracy. Retrieval on large-scale datasets further manifests such advantages.

FIG. 1 shows an exemplary database indexing process. FIG. 1 shows a general indexing framework to index database images. Input images are provided to a feature extraction engine. The system of FIG. 1 first extract features from the database images. Then these features are indexed according to their image ID into an indexing structure done in FIG. 2. After obtaining all the groups, we index each group using only local features for simplicity using methods described in 101 of FIG. 2. Database images are indexed with a two-layer indexing structure: Group layer index and image layer Index. In FIG. 2's 101, the two-layer indexing structure to index database images operates on a group layer and an image layer. The group layer indexing encodes the image descriptor and group id correspondence. The image layer indexing encodes the image and group correspondence.

We observe that in image database, many images share strong relevance with each other. Rather than indexing these images individually, we propose to package these images into one basic unit for indexing and retrieval. We call such basic units containing highly relevant images as grouplets.

In contrast to traditional methods which use image id to index the local feature descriptor, we use group id to index a local feature descriptor. The group layer index enables fast group search using inverted index. Similar to previous work, we use a vocabulary tree structure to perform the first layer descriptor indexing task. The second image layer index allows retrieving images from searched groups. The image layer index is naturally obtained in the group constructing process.

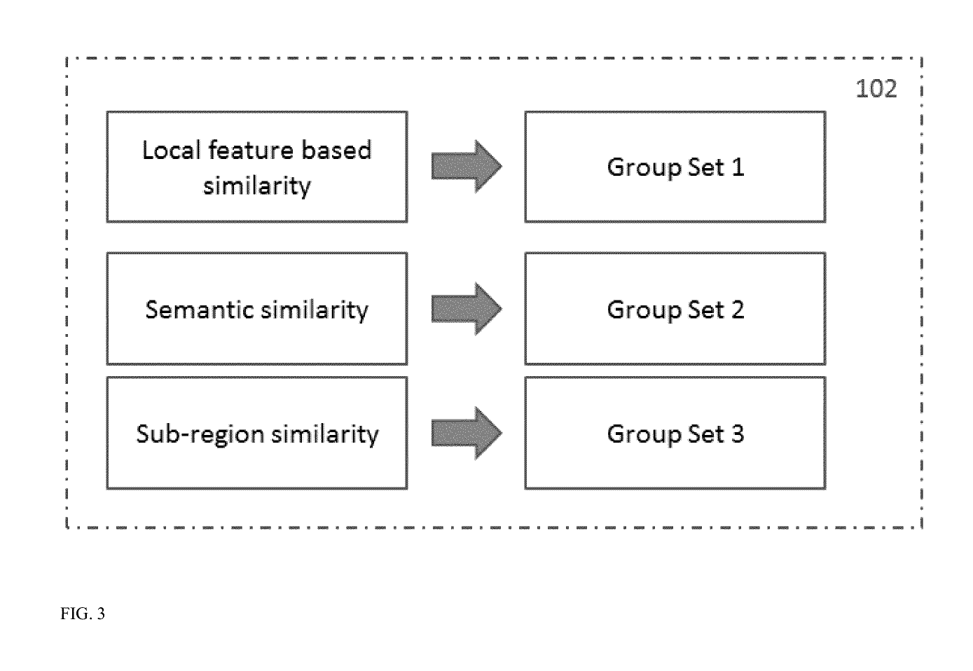

FIG. 3 shows in more details an exemplary indexing structure with a two-layer indexing structure. Firstly we construct groups using three different types of information as shown in 102: 1) local feature similarity 2) Region similarity 3) Global high level feature similarities. For example, an image group can be constructed if all the images in the group have similar local features. Similar group constructing process can be applied to 2) and 3). Different from existing methods, which take each individual image to apply independent indexing, we apply indexing for database images for image groups we constructed.

FIG. 3's module 102 shows an exemplary group construction using three different image similarity measurements: Local feature similarity, semantic similarity and sub-region similarity. Local feature similarity models local content similarity between images. Semantic similarity measures the semantic meaning similarity between two images. As illustrated in FIG. 3, indexing grouplets rather than single images achieves a compact index file, because the number of grouplets is significantly smaller than the number of single images. More importantly, indexing grouplets allows us to seamlessly integrate different image features and image content analysis techniques during off-line indexing. In FIG. 3, we generate grouplets with different levels of similarities, i.e., local, regional, and global similarities, and index these groups together with inverted indexes. Therefore, in the final index, images with either similar semantics, similar local descriptors, or similar object regions could be organized together. This would significantly improve the discriminative power and compactness of the index file and hence is superior to existing hashing, inverted files, and retrieval fusion strategies.

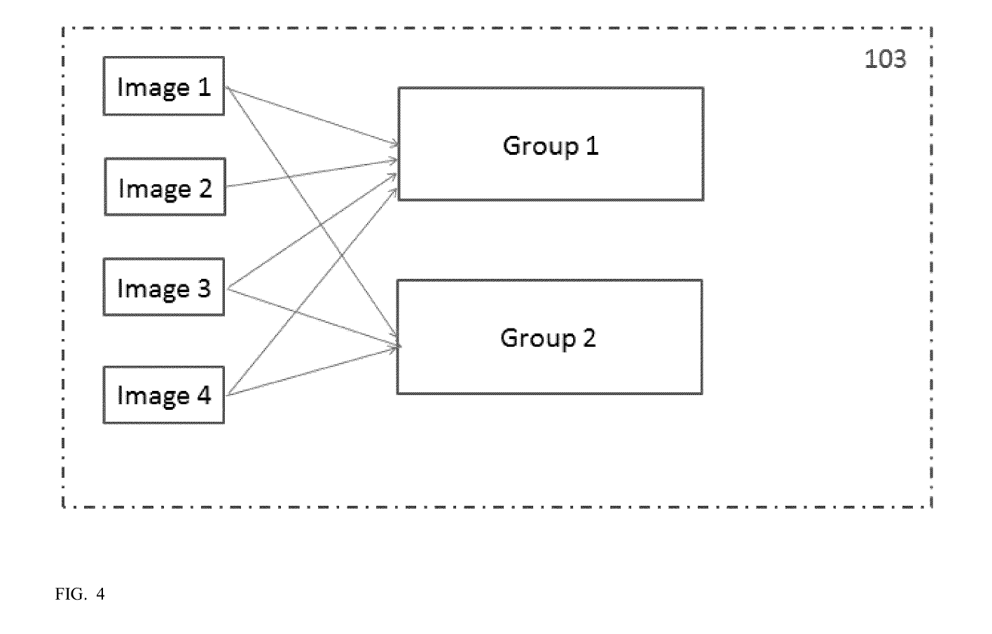

FIG. 4 shows an exemplar cross indexing module 103 which allows an image to appear in multiple groups. If one image is only allowed to be in one group, then the whole dataset will be divided into disjoint sets. The retrieval result would be very sensitive to the group construction result. Our cross indexing framework is robust to the group construction result.

During the query, we first extract local features from the query image. Through each descriptor, we retrieve corresponding groups via descriptor-group indexing. Then we find the images through the image-group indexing. The retrieve score of an image in the database is aggregated if the image is retrieved by multiple descriptors. We allow each image to be in multiple groups which we call as cross connected image to group mapping. If an image belongs to at most one group, then all images in a group have exactly the same retrieval score. It cannot differentiate images inside the same group. Our framework enables multiple groups to vote scores for one image. So the retrieval score for two images could be different even they are in the same group.

In one embodiment, we have an image dataset D={d₁, d₂, . . . , d_{M}}. In cross indexing, we represent the database as a collection of grouplets, i.e., G={G₁, G₂, . . . , G_{N}} generated on D. We define a grouplet Gₐ as a collection of images, i.e.,

Gₐ:{dᵢ}_{iεG}_{ₐ},|Gₐ|≧1,∀_{b,b≠a}G_{b}⊂Gₐ,Gₐ⊂G_{b}, (1)

where |·| is cardinality of G, i.e. the number of images in a grouplet. Because indexing more grouplets results in larger memory cost, we require each grouplet is not the subset of any other to control the number of grouplets. We denote the collection of grouplets containing image dᵢ as Gᵢ, GᵢεG. Because dᵢ could belong to multiple grouplets, |Gᵢ|≧1.

Based on such grouplet representation in cross indexing, during online retrieval the similarity between query q and database image dᵢ could be formulated as,

s̅i̅m̅(q,dᵢ)=Σ_{G}_{ₐ}_{εG}_{ᵢ}sim(dᵢ,Gₐ) (2)

where we use the similarities between grouplets and query, i.e., sim(·) to vote the similarity between query and database images. Therefore, Eq. (2) differs from the TF-IDF (Term Frequency-Inverse Document Frequency) similarity in inverted file indexing, which directly computes the similarity between query and database images.

According to Eq. (2), images in the same grouplet would present more consistent similarity with query than the ones in different grouplets. Therefore the quality of generated grouplet would largely affect the similarity computation in image retrieval after cross indexing. To make the image retrieval valid, grouplets should embed discriminative relations among images to ensure closely related images share more consistent similarities with the query. This guides the formulation of our grouplet generation, i.e.,

$${min}_{G} {\sum }_{i , j = 1}^{M} {\vert {\vert \overline{dis} ( q , {d}_{i} ) - \overline{dis} ( q , {d}_{j} ) \vert}_{1} - D ( i , j ) \vert}_{1} + λ \vert G \vert , \qquad ( 3 )$$

where D denotes the given distance matrix, which can be computed by customized measurements like semantic meaning, or local visual similarity, d̅i̅s̅(q,dᵢ) is the distance between query q and dᵢ after cross indexing. Similar to Eq. (2), it is computed by comparing q to the grouplets in Gᵢ·λ|G| is the regularization term to control the number of generated grouplets. According to the distance relationship, we could simplify the above equation as,

$${min}_{G} {\sum }_{i , j = 1}^{M} {\vert DIS ( {G}_{i} , {G}_{j} ) - D ( i , j ) \vert}_{1} + λ \vert G \vert , \qquad ( 4 )$$

where DIS(·) denotes the distance between two collections of grouplets. By replacing DIS(·) and D with the followings:

SIM(Gᵢ,Gⱼ)=1−DIS(Gᵢ,Gⱼ)=Gᵢ∩Gⱼ/Gᵢ∪Gⱼ (4)

S(i,j)=1−D(i,j),S(i,j)=S(j,i),S(i,j)ε{0,1}(5)

we could reasonably simply Eq. (4) as,

$${min}_{G} {\sum }_{i , j = 1}^{M} {\vert SIM ( {G}_{i} , {G}_{j} ) - S ( i , j ) \vert}_{1} + λ \vert G \vert , \qquad ( 6 )$$

where SIM (·) denotes the similarity between two collections of grouplets, and matrix S can be seen as an undirected graph representing the customized relations among database images. Grouplet generation is hence equivalent to dividing this graph into subgraphs that satisfy: 1) images in the same subgraph should be highly relevant to each other and irrelevant images should appear in different subgraphs; 2) the number of subgraphs should be small to save memory.

According to the graph theory, a clique in an undirected graph is defined as a subset of vertexes, in which every two vertices are connected. A maximal cliques is a clique that cannot be extended by including one more adjacent vertex. Hence, optimizing Eq. (6) is equivalent to finding all maximal cliques in an undirected graph, i.e., images within a maximal clique are connected with each another, and minimum number of cliques can be generated. Therefore, grouplet generation could be reasonably solved by seeking all maximal cliques in a graph defined by S.

In one embodiment, a mutual kNN graph is used to reveal the relevance relations among images, and then seek all maximal cliques in it as grouplets. Suppose dᵢ, dⱼ are mutual kNNs of each other, they should satisfy

dᵢεkNN(dⱼ);dⱼεkNN(dᵢ), (7)

where kNN(·) denotes the k-Nearest Neighbors of an image.

The edges represent the mutual-kNN relationships. It is obvious that mutual kNN reveals reliable relevances among images. Based on the mutual kNN relations, we could build a sparse graph H=(V,S), where V is the vertex set, i.e., the database images, and S stores the edges among vertices, i.e., if dᵢ and dⱼ are mutual kNNs of each other, then S(i,j)=1.

Finding all maximal cliques in a graph is a NP-complete problem. Despite of this hardness, plenty of efficient algorithms have been studied. In, Makino et al. propose the output-sensitive algorithm based on fast matrix multiplication, which finds about 100,000 maximal cliques per second from a sparse graph. In this paper, we employ the method of to find maximal cliques. By constructing sparse graphs with properly selected parameter k, the maximal cliques can be efficiently identified.

It can be observed that images sharing strong relevance could be identified as one grouplet. The isolated image not similar to others compose a grouplet containing itself. This necessarily ensures the high relevance among images in each grouplet. As aforementioned, the parameter k decides the sparseness of matrix S, hence it largely decides the number and quality of generated grouplets. In cross indexing, the intermediate grouplet layer allows seamless integration of different image content analysis techniques through customizing the mutual kNN relations. We use three complementary clues to generate the final grouplet collection, i.e., G={G⁽¹⁾, G^{(r)}, G^{(g)}}

G⁽¹⁾ denotes grouplets generated with local descriptors. We could employ vocabulary tree to compute BoWs models, build inverted indexes for database images, and finally compute the TF-IDF similarities to build the mutual kNN graph. Recent works on local descriptor based image search [?, ?] and image relation computation [?, ?, ?, ?] can also be used to improve the quality of G⁽¹⁾. Because local descriptor and the vocabulary tree are mainly used in partial-duplicate image search, G⁽¹⁾ effectively organizes the partial-duplicate images together into the same grouplet.

G^{(r)} denotes grouplets generated with regional features. We first densely generate the initial regions on an image through over segmentation. After rejecting the regions with too large or too small sizes, we compute a matrix storing the overlap rates among the remained regions. Affinity Prorogation is hence applied on this matrix to cluster these regions. We finally keep at most 5 clusters and select the largest region in each of them to represent this image. Suppose the region collections of two images dᵢ and dⱼ are {rₘ}_{mεi} and {rₙ}_{nεj}, respectively, we define the regional image similarity as:

$${S}_{r} ( {d}_{i} , {d}_{j} ) = \frac{{\sum }_{m ∈ i} {max}_{n ∈ j} ( s ( {r}_{m} , {r}_{n} ) )}{\vert {r}_{m} \vert} + \frac{{\sum }_{n ∈ i} {max}_{m ∈ j} ( s ( {r}_{m} , {r}_{n} ) )}{\vert {r}_{n} \vert} , \qquad ( 8 )$$

where |·| is the cardinality of a set, i.e., the number of regions in dᵢ or dⱼ, respectively, s(·) returns the similarity between feature vectors of two image regions. We hence could build a graph using the defined regional similarity Sᵣ(·). Because regions tend to capture the object-level clues and may eliminate the negative effects of background clutters, G^{(r)} is expected to organize images with similar objects into the same grouplet.

G^{(g)} denotes grouplets generated with global similarity. We simply use the similarity computed with global features to construct the mutual kNN graph for G^{(g)} generation. G^{(g)} hence tends to organize images with similar global appearances into the same grouplet.

In cross indexing, we mix different types of grouplets together and then proceed to index them with the two-layer indexing structure. Because relevant images many be similar in multiple aspects, e.g., local and global appearances, there may exist redundant grouplets. To remove such redundancy and save memory cost, we define the similarity of two grouplets as

S_{G}(Gₐ,G_{b})=|Gₐ∩G_{b}|/|Gₐ∪G_{b}|, (9)

where |·| is cardinality of G, i.e. the number of images in a grouplet. With Eq. (9), we discard the smaller grouplet if the similarity of two grouplets is larger than α. In this paper, we experimentally set α=0.8.

After removing the redundant grouplets, we follow the inverted file indexing paradigm to construct the grouplet index. We first extract and encode local descriptors into visual words with a vocabulary tree containing millions of visual words, then compute TF (Term Frequency) vectors of grouplets. For grouplets containing only one image, we directly compute the L-1 normalized visual word histogram as the TF vector. For grouplets containing multiple images, we first compute the TF vector of each image and then employ the max pooling strategy, which is well suited to the sparse TF vector as discussed in. For a grouplet G:{dᵢ}_{iεG}, the TF value of visual word v in G is computed as:

$${TF}_{G} ( v ) = {max}_{i ∈ G} ( {TF}_{{d}_{i}} ( v ) ) \qquad ( 10 )$$

where TFᵢ denotes the L-1 normalized TF vector of database image dᵢ.

Based on the TF vectors of all grouplets, we index them in the grouplet index, where each cell in the index records the TF value of a visual word and the ID of a grouplet. We further build the second layer index to record the grouplet-image relations. The gouplet-image relation is acquired during the grouplet generation process.

Because of the two-layer indexing structure, our online retrieval procedure consists of two steps. The first step is almost identical to the BoWs based image retrieval in, i.e., extracting and quantizing SIFT descriptors into visual words and computing the TF-IDF similarity, i.e.,

sim(dᵢ,Gₐ)=Σᵥ^{IDF}(v)×min(TF_{d}_{ᵢ}(v),TF_{G}_{ₐ}(v)). (11)

This process returns grouplets sharing similar local descriptors with the query.

According to the grouplet-image relation recorded in image index, we then unpack these grouplets into a list of single images. As illustrated in Eq. (2), the similarity between query q and database image dᵢ is computed by voting the similarities of q and grouplets containing dᵢ.

Because we generate grouplets with different aspects of similarities, images consistent with query in multiple aspects would be returned first. This is superior to most of existing local descriptor based image retrieval systems, which mainly focus on retrieving partial-duplicate images of the query. In addition, our retrieval strategy only extracts local descriptors for query, hence is also superior to most of retrieval fusion strategies, which either need to fuse multiple features or multiple results during online retrieval.

One embodiment uses Cross Indexing with Grouplets to view the database images as a set of grouplets, each of which is defined as a group of highly relevant images. The number of grouplets is smaller than the number of images, thus naturally leading to less memory cost. Moreover, the definition of a grouplet could be based on customized relations, allowing for seamless integration of advanced data mining techniques in off-line indexing. The cross indexing with grouplets views the database images as a set of grouplets and builds a two-layer indexing structure to achieve efficient image retrieval. We define each grouplet as a set of highly relevant images to eliminate the redundancy. Moreover, the definition of a grouplet could be based on customized relations, allowing for seamless integration of advanced data mining techniques in off-line indexing. Our framework is instantiated with three different types of grouplets by seeking the maximal cliques in mutual kNN graphs defined by local similarities, regional relations, and global visual features, respectively. To validate the system, we construct three different types of grouplets, which are respectively based on local similarities, regional relations, and global visual modeling. Extensive experiments on public benchmark datasets demonstrate the efficiency and superior performance of our approach.

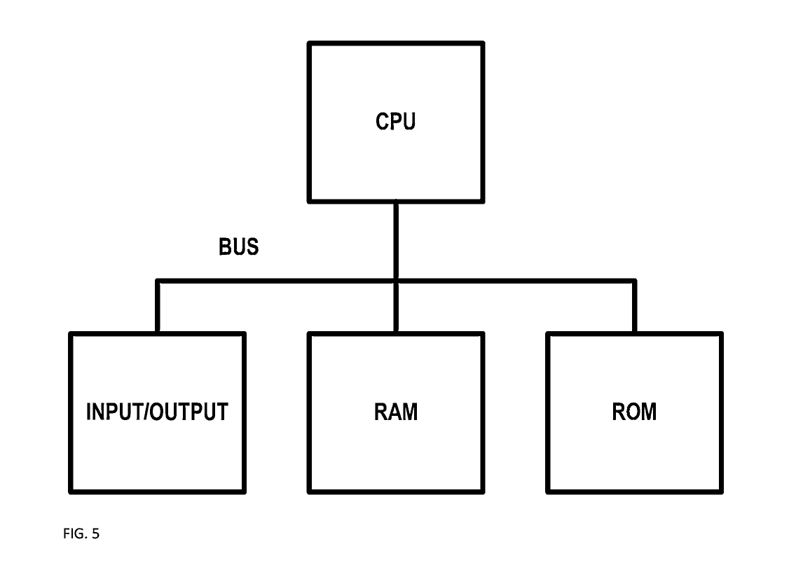

The system may be implemented in hardware, firmware or software, or a combination of the three. FIG. 5 shows an exemplary computer to execute the system discussed above.

Preferably the invention is implemented in a computer program executed on a programmable computer having a processor, a data storage system, volatile and non-volatile memory and/or storage elements, at least one input device and at least one output device.

By way of example, a block diagram of a computer to support the system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself

What is claimed is:

1. A method to respond to a query for one or more images, comprising:
capturing images with a camera and using a processor, applying an indexing strategy to process images as grouplets rather than individual single images;
generating a two layer indexing structure with a group layer, each associated with one or more images in an image layer;
cross-indexing the images into two or more groups; and
retrieving near duplicate images with the cross-indexed images and the grouplets.

2. The method of claim 1, wherein the generating two-layer indexing structure comprises constructing groups using three different types of information.

3. The method of claim 2, wherein the types of information comprise a local feature similarity, a region similarity, and global high level feature similarities.

4. The method of claim 1, comprising extracting local features from the query image during the query.

5. The method of claim 4, comprising using each descriptor and retrieving corresponding groups via descriptor-group indexing.

6. The method of claim 5, comprising finding one or more images through the image-group indexing.

7. The method of claim 1, comprising generating a score of an image in the database and aggregating the score if the image is retrieved by multiple descriptors.

8. The method of claim 1, comprising determining each image in multiple groups as cross connected image to group mapping.

9. The method of claim 8, wherein if an image belongs to at most one group, then all images in a group have exactly the same retrieval score.

10. The method of claim 1, comprising allowing multiple groups to vote scores for one image and generating different retrieval scores for two images even they are in the same group.

11. The method of claim 1, comprising applying a group layer index for fast group search using an inverted index.

12. The method of claim 1, comprising using a vocabulary tree structure to perform a first layer descriptor indexing.

13. The method of claim 1, comprising generating a second image layer index that allows retrieving images from searched groups.

14. The method of claim 1, comprising obtaining an image layer index in a group constructing process.

15. The method of claim 1, comprising generating a group layer index that encodes an image descriptor and a group identification correspondence.

16. The method of claim 1, comprising generating an image layer indexing that encodes an image and group correspondence.

17. The method of claim 1, wherein the local feature similarity models local content similarity between images.

18. The method of claim 1, comprising generating a semantic similarity measuring a semantic meaning similarity between two images.

19. The method of claim 1, comprising
extracting and quantizing SIFT descriptors into visual words and computing the TF-IDF similarity using
sim(dᵢ,Gₐ)=ΣᵥIDF(v)×min(TF_{d}_{ᵢ}(v),TF_{G}_{ₐ}(v)).
where IDF(v) is an inverted document frequency of visual word v, TF_{d}_{_{—}}ᵢ(v) is the term frequency of descriptor i, TF_{Ga} is a term frequency of the grouplet, and sim(dᵢ, Gₐ)$ is a similarity between dᵢ and Gₐ.
obtaining grouplets sharing similar local descriptors with the query; and
according to the grouplet-image relation recorded in image index, unpacking the grouplets into a list of single images, wherein a similarity between query q and database image dᵢ is determined by voting similarities of q and grouplets containing dᵢ.

20. The method of claim 1, comprising:
removing redundant grouplets and performing an inverted file indexing to construct a grouplet index;
extracting and encoding local descriptors into visual words with a vocabulary tree of visual words, then computing TF (Term Frequency) vectors of grouplets;
for grouplets containing only one image, determining L-1 normalized visual word histogram as the TF vector;
for grouplets containing multiple images, determining TF vector of each image and then applying a max pooling strategy where for a grouplet G:{dᵢ}_{iεG}, a TF value of visual word v in G is computed as:
$${TF}_{G} ( v ) = {max}_{i ∈ G} ( {TF}_{{d}_{i}} ( v ) )$$
where TFᵢ denotes the L-1 normalized TF vector of database image dᵢ.
